(19) United States
(12) Patent Application Publication
(10) Pub. No.: US 2026/0154402 A1
(43) Pub. Date: Jun. 4, 2026

(54) ADAPTIVE AND CONTEXT-AWARE SCANNING

(71) Applicant: CrowdStrike, Inc., Sunnyvale, CA (US)

(72) Inventors: Sivakumar Mandalam, San Jose, CA (US); Jeevanandam Kathirvel, Bengaluru (IN); Rahul Vedpathak, Pune (IN)

(21) Appl. No.: 18/965,043

(22) Filed: Dec. 2, 2024

(51) Int. Cl. G06F 21/55

(52) U.S. Cl. CPC G06F 21/554; G06F 2221/034

(57) ABSTRACT

The present disclosure provides techniques for adaptive and context-aware scanning. A processing device obtains a set of metrics associated with at least one of: a target device in a network or the network. The processing device determines, based on the set of metrics, a time instance at which to perform a scan of the target device. The processing device performs the scan of the target device at the time instance.

### TECHNICAL FIELD

Aspects of the present disclosure relate to cybersecurity, and more particularly, to adaptive and context-aware scanning.

### BACKGROUND

Cybersecurity refers to the practice of protecting computer systems, networks, and digital assets from theft, damage, unauthorized access, and various forms of cyber threats. Cybersecurity threats encompass a wide range of activities and actions that pose risks to the confidentiality, integrity, and availability of computer systems and data. These threats can include malicious activities such as viruses, ransomware, and hacking attempts aimed at exploiting vulnerabilities in software or hardware.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example of a system for adaptive and context-aware scanning in accordance with some aspects of the present disclosure.

FIG. 2 is a block diagram that illustrates an example of an industrial control systems (ICS) environment in accordance with some aspects of the present disclosure.

FIG. 3 is a block diagram that illustrates an example of a system for adaptive and context-aware scanning in accordance with some aspects of the present disclosure.

FIG. 4 is a flow diagram of a method of adaptive and context-aware scanning in accordance with some aspects of the present disclosure.

FIG. 5 is a flow diagram of a method of adaptive and context-aware scanning in accordance with some aspects of the present disclosure.

FIG. 6 illustrates a diagrammatic representation of a machine in an example form of a computer system that may perform one or more of the operations described herein in accordance with some aspects of the present disclosure.

### DETAILED DESCRIPTION

The term industrial control systems (ICS) refers to a collection of devices, systems, networks, and controls that regulate and manage machines and processes in industrial settings. A network scanner may be used to discover and/or monitor an ICS device for various purposes, including cybersecurity threat detection. In an example, the network scanner uses a native query to elicit information from the ICS device by sending packets to the ICS device and analyzing the responses.

Various factors exist that may cause issues when a network scanner scans an ICS device. For example, an ICS device may be busy when being scanned by a network scanner, and thus may be unavailable to send a response to the network scanner. In another example, network scanners may overwhelm an ICS device by sending repeated queries to the ICS device, which may cause the ICS device to fail. An ICS network stack may be fragile, and a failed ICS device may impact an overall ability of an ICS network. In yet another example, an overall state of the ICS network may be congested which may affect an ability of the network scanner to scan the ICS device. Failing to scan an ICS device may impact an ability to detect threats to the ICS network.

The present disclosure addresses the above-noted and other deficiencies by using a processing device for adaptive and context-aware scanning. With more particularity, the present disclosure implements scanning techniques that adapt based on various factors such as device type, network conditions, and/or operational context in order to minimize a disruption associated with scanning of an ICS device. For instance, the present disclosure provides for techniques to select a time instance at which to perform a scan of an ICS device that reduces disruptions associated with scanning the ICS device and that increases a likelihood of the scan being successful.

In an example, a processing device obtains a set of metrics associated with at least one of: a target device in a network or the network. The processing device determines, based on the set of metrics, a time instance at which to perform a scan of the target device. The processing device performs the scan of the target device at the time instance.

As discussed herein, the present disclosure provides an approach that improves the operation of a computer system by reducing a chance that a target device (e.g., an ICS device) fails due to undergoing a scan. For example, via determining a time instance at which to perform a scan of a target device based on a set of metrics associated with the target device and/or the network, the present disclosure may facilitate the target device being scanned at an optimal time (e.g., a time when the target device is not busy). In addition, the present disclosure provides an improvement to the technological field of cybersecurity by reducing a chance that a scan of a target device fails. For example, via determining a time instance at which to perform a scan of a target device based on a set of metrics associated with the target device and/or the network, the present disclosure may facilitate successful completion of scans, which may improve an ability to detect threats to the network and/or the target device.

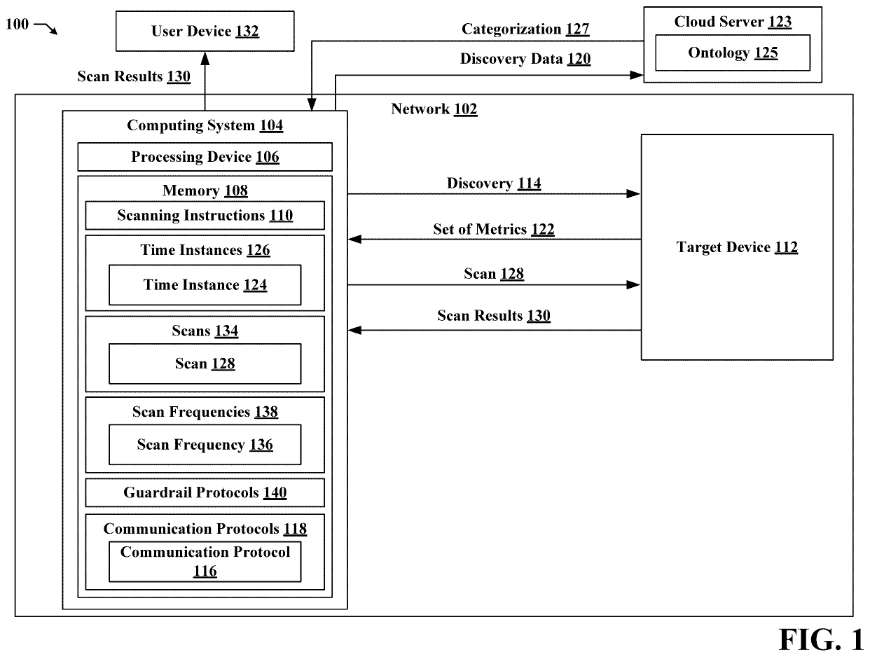

FIG. 1 is a block diagram 100 that illustrates an example of a system for adaptive and context-aware scanning in accordance with some aspects of the present disclosure. The system may include a network 102. In an example, the network 102 may be an ICS network that includes ICS devices.

The network 102 may include a computing system 104. The computing system 104 may include a processing device 106 (e.g., a central processing unit (CPU)) and memory 108. The memory 108 may store scanning instructions 110 that, when executed by the processing device 106, cause the processing device 106 to perform adaptive and context-aware scanning as described herein.

The network 102 may also include a target device 112. In an example, the target device 112 may be an ICS device, such as an ICS device that controls physical processes in an ICS environment. In another example, the target device 112 may be an Internet-of-Things (IOT) device. In an example, the target device 112 may communicate via a non-transmission control protocol (non-TCP) protocol, such as a user datagram protocol (UDP), an Internet control message protocol (ICMP), or non-Internet protocol (non-IP) networking. In an example, the target device 112 may communicate via a Profinet protocol, a modbus protocol, an ethernet Internet Protocol (IP), an S7comm protocol, an open platforms communications (OPC) unified architecture (UA) protocol, modbus TCP, etc. In an example, the target device 112 may include a processing device, memory, a network interface device, etc. (not shown in FIG. 1).

The computing system 104 may perform a discovery 114 of the target device 112, that is, the computing system 104 may discover the target device 112. In an example, the computing system 104 may transmit packets to the target device 112 and obtain a response from the target device 112 based on the packets in order to discover the target device 112. In some aspects, the computing system 104 may obtain a medium access control (MAC) address of the target device 112. The MAC address may include an organizationally unique identifier (OUI). The computing system 104 may determine a type of the target device 112 based on the OUI. The computing system 104 may select a communication protocol 116 from amongst communication protocols 118 based on the type of the target device 112. In an example, the communication protocols 118 may include a Profinet protocol, a modbus protocol, an ethernet IP, an S7comm protocol, an OPC UA protocol, modbus TCP, etc. The computing system 104 may use the communication protocol 116 in order to communicate with the target device 112.

In some aspects, concurrently or subsequent to performing the discovery 114, the computing system 104 obtains discovery data 120 associated with the target device 112. The discovery data 120 may include characteristics of the target device 112. In an example, the discovery data 120 may include the MAC address of the target device 112. The computing system 104 may transmit the discovery data 120 to a cloud server 123. The cloud server 123 may maintain an ontology 125 that maps device characteristics to categorizations of devices. The cloud server 123 may determine a categorization 127 of the target device 112 based on the ontology 125 and the discovery data 120. The cloud server 123 may transmit an indication of the categorization to the computing system 104. The computing system 104 may select the communication protocol 116 from amongst communication protocols 118 based on the categorization 127. The computing system 104 may use the communication protocol 116 in order to communicate with the target device 112. In some other aspects, the computing system 104 maintains the ontology 125 and the computing system 104 determines the categorization 127 based on the ontology 125.

The computing system 104 may obtain a set of metrics 122 associated with the target device 112 and/or the network 102. In some aspects, the set of metrics 122 may be included in a JavaScript Object Notation (JSON) file. For example, the computing system 104 may receive the set of metrics 122 from the target device 112, from another device, and/or the computing system 104 may determine the set of metrics 122 based on data received from the target device 112. In an example, the computing system 104 obtains the set of metrics 122 by communicating with the target device 112 using the communication protocol 116. The set of metrics 122 may include a round-trip time for a packet between a scanner (e.g., the computing system 104) and the target device 112, an amount of data transmitted over the network 102, a variation in packet arrival times associated with the target device 112, a location of the target device 112, an operational schedule of the target device 112, a maintenance window of the target device 112, and/or packet loss associated with the target device 112. In some examples, the computing system 104 may obtain the set of metrics 122 via a supervisory control and data (SCADA) system application programming interface (API), via an open platform communications (OPC) unified architecture (UA), via a simple network management protocol (SNMP), and/or via a modbus poll.

The computing system 104 may determine a time instance 124 at which to scan the target device 112 based on the set of metrics 122. In some aspects, the computing system 104 may determine the time instance 124 additionally based on a type of the target device 112, the categorization 127 of the target device, and/or the discovery data 120. In an example, the time instance 124 may be selected from amongst (multiple) time instances 126. In some aspects, the time instance 124 may be associated with a processor usage of the target device 112 being below a threshold processor usage, a memory usage of the target device 112 being below a threshold memory usage, and/or a network usage of the network 102 being below a threshold network usage.

The computing system 104 may perform a scan 128 of the target device 112 at the time instance 124. The computing system 104 may obtain scan results 130 based on the scan 128. For example, computing system 104 may receive the scan results 130 from the target device 112. The computing system 104 may perform actions based on the scan results 130. In an example, the computing system 104 may transmit the scan results 130 to a user device 132, whereupon the user device 132 may present the scan results 130 to a user (e.g., on a display). In another example, the computing system 104 may control the target device 112 based on the scan results 130. In yet another example, the computing system 104 may perform a cybersecurity associated action based on the scan results 130. For instance, the computing system 104 may quarantine the target device 112 based on the scan results 130.

In some aspects, the computing system 104 may select the scan 128 from amongst scans 134 based on the time instance 124, a type of the target device 112, the categorization 127 of the target device 112, and/or the set of metrics 122. In an example, the scans 134 may include a port scan, an operating system (OS) detection scan, a UDP scan, a file scan, and/or a vulnerability scan. A port scan may find ports associated with the target device 112 and identify whether the ports are open, closed, or filtered. An OS detection scan may identify an OS of the target device 112, a version of the OS of the target device 112, and other details pertaining to the OS of the target device 112. A UDP scan uses UDP protocols for scanning, which may be useful for scanning UDP-based services. A file scan may use a script to identify outdated services associated with the target device 112 that are vulnerable to known security issues. A vulnerability detection scan may execute probes with respect to the target device 112 to check for specific vulnerabilities. In an example, the computing system 104 may perform a port scan of the target device 112 at the time instance 124 when the time instance 124 is associated with a relatively busy period for the target device 112, whereas the computing system 104 may perform a file scan of the target device 112 at the time instance 124 when the time instance 124 is associated with an inactive period for the target device 112.

In some aspects, the computing system 104 may determine a scan frequency 136 for the scan 128 based on the time instance 124, the type of the target device 112, the categorization 127 of the target device 112, the set of metrics 122, and/or a type of the scan 128. In some aspects, the computing system 104 may select the scan frequency 136 from amongst scan frequencies 138 based on the time instance 124, the type of the target device 112, the categorization 127 of the target device 112, the set of metrics 122, and/or the type of the scan 128. In an example, the scan frequencies 138 may include once a minute, once an hour, once a day, etc. The computing system 104 may perform the scan 128 at the scan frequency 136. For example, if the scan frequency 136 is once an hour, the computing system 104 may perform the scan 128 once every hour.

In some aspects, the computing system 104 may perform the discovery 114, obtain the set of metrics 122, and/or perform the scan 128 based on guardrail protocols 140 configured to minimize disrupting the target device 112 and/or the network 102. In an example, the guardrail protocols 140 may include avoiding using native queries originating from a network scanner, avoiding overloading the network 102, avoiding overloading a source and destination endpoint used for scanning, using a single backet to broadcast and address to elicit a response from multiple hosts, avoiding performing repeated or aggressive scans, performing safe, read-only operations, using a longer timeout period for responses to avoid marking slower devices as down, utilizing lightweight packets, limiting a rate and a volume of transmitted packets, using checks that do not modify a state of a device, using passive techniques, such as listening for responses to broadcast queries, utilizing multiple protocols to increase a likelihood of discovering hosts without causing disruptions, using safe scan techniques and options, avoiding collecting superfluous information, fragmenting packets to make the packets less likely to overwhelm devices, utilizing particular flags, executing unicast probes based on device attributes, taking precautions using TCP/UDP, waiting and closing sessions properly, utilizing read-only SNMP requests, scanning devices according to a priority order, ensuring that resource priority of devices are capped and are user adjustable, ensuring that log files are capped and can be modified by an end user, ensuring that user permissions for the scan are less than permissions for cybersecurity software, profiling network characteristics of queries in order to understand a number of packets, effects of the packets on the network, and destinations of the packets, and/or using different data models for different scans.

In some aspects, the computing system 104 may perform the discovery 114, obtain the set of metrics 122, and/or perform the scan 128 via a broadcast. Characteristics of the broadcast may include scanning multiple interfaces in a multi-homed network, where a user specifies one, two, or zero interface options. The characteristics of the broadcast may include using a single packet for the broadcast address to elicit a response from multiple hosts, avoiding repeated or aggressive scanning to prevent network congestion, performing safe, real-only operations, using longer timeouts for responses to avoid marking slower devices as down, utilizing lightweight packets, limiting a rate and a volume of packets to avoid overwhelming devices, using checks that do not modify a state of a device, using passive techniques, such as listening for responses to broadcast queries, and/or utilizing multiple broadcast protocols to increase a likelihood of discovering hosts without causing disruptions.

In some examples with respect to utilizing multiple broadcast protocols, the computing system 104 may use an address resolution protocol (ARP) request to discover hosts within a local network. In another example, the computing system 104 may use multicast domain name system (mDNS) to discover devices that respond to service discovery request. In an additional example, the computing system 104 may use a single ICMP echo request to collect ICMP echo replies from responsive hosts. The single ICMP echo request may determine if a device is reachable, but not a type of the device. In some aspects, the computing system 104 uses ICMP echo requests for relatively small networks and avoids using ICMP echo requests in large network scans, uses a rate limit for the ICMP echo requests to avoid overwhelming a network and devices, and/or avoids sending ICMP echo requests for subsequent scans (e.g., avoid segments that have programmable logic controls (PLC)).

In another example, the computing system 104 may use specialized protocol broadcast queries when general network discovery protocols (e.g., ICMP, mDNS, ARP, etc.) fail to elicit a response or are blocked due to a security policy. In a further example, the computing system 104 may discover live hosts outside of a broadcast network. For instance, the computing system 104 may obtain a list of known gateways. The computing system 104 may use ARP requests to target known gateways and discover connected devices. The computing system 104 may also obtain a list of known switches and routes. The computing system 104 may use SNMP requests to query network switches and routes to retrieve MAC address tables of other switches. The SNMP requests may be read-only requests. If credentials are required for the SNMP requests, the credentials may be provided via user input. The computing system 104 may obtain a list of devices and MAC addresses of devices in the list of devices based on the ARP requests and the SNMP.

In a further example, the computing system 104 may identify vendors using a MAC address. For instance, the computing system 104 may use an OUI lookup to identify device vendors. The computing system 104 may map MAC addresses to vendors using the OUI lookup. The computing system 104 may use a generic unicast network probe using network protocols such as hypertext transfer protocol (HTTP), Telnet, SNMP, and TCP/UDP scanning if packets originating from the network protocols are lightweight. The computing system 104 may map vendors to specialized protocols via a mapping table that maps vendors to commonly used ICS/operational technology (OT) protocols.

In some aspects, the computing system 104 may perform the discovery 114, obtain the set of metrics 122, and/or perform the scan 128 via a unicast. For instance, the computing system 104 may execute unicast probes (for device protocols) based on a device attribute, transmit unicast probes serially for discovered devices, assemble device profiles in the cloud, perform safe, read-only operations, ensure that packets are lightweight, limit a rate and volume of packets to avoid overwhelming network devices, use checks that do not modify a state of target devices, and/or close a session when using TCP as a communication protocol.

The computing system 104 may adapt scanning based on changing circumstances of the network 102 and/or the target device 112. For example, subsequent to performing the scan 128, the computing system 104 may obtain a second set of metrics associated with the target device 112 and/or the network 102. The second set of metrics may differ from the set of metrics 122. For instance, the set of metrics 122 may include/indicate a first round-trip time for a packet transmitted between the computing system 104 and the target device 112 and the second set of metrics may include/indicate a second round-trip time for a packet transmitted between the computing system 104 and the target device 112, where the first round-trip time is different from the second round-trip time. The computing system 104 may determine a second time instance at which to perform a second scan of the target device 112 based on the second set of metrics. The second scan may be of the same type as the scan 128 or the second scan may be a different type of scan compared to the scan 128. The computing system may perform the second scan of the target device 112 at the second time instance. In some aspects, a frequency of the second scan may be different from a frequency of the scan 128 and the computing system 104 may perform the second scan of the target device 112 at the frequency of the second scan.

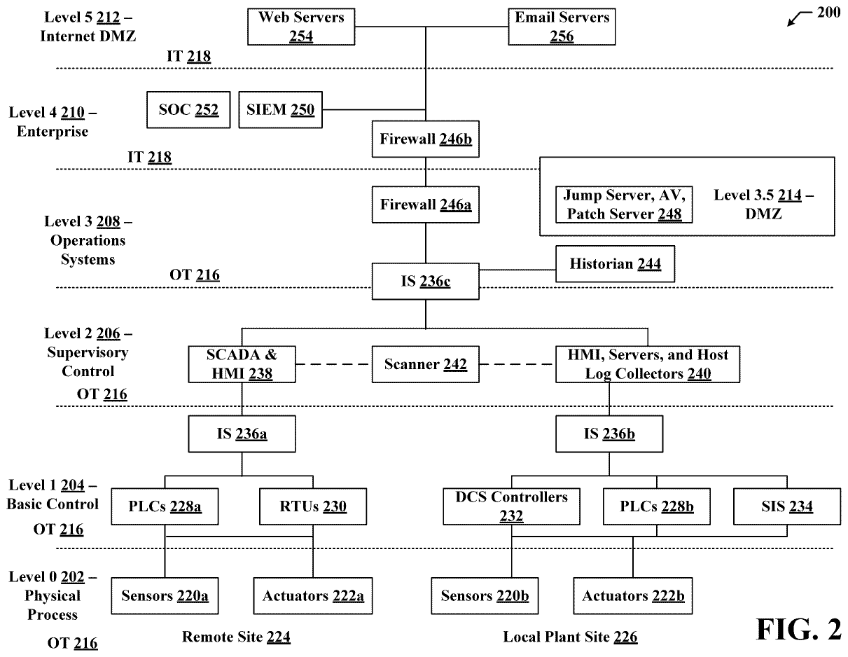

FIG. 2 is a block diagram 200 that illustrates an example of an ICS environment in accordance with some aspects of the present disclosure. In an example, the ICS environment may include and/or be associated with the network 102 described above in the description of FIG. 1. The ICS environment may include level 0 202 (physical process), level 1 204 (basic control), level 2 206 (supervisory control), level 3 208 (operations systems), level 4 210 (enterprise), and level 5 Internet demilitarized zone (DMZ) 212. The ICS environment may also include level 3.5 214 (DMZ). A DMZ may refer to a subnetwork that separates a private network of an organization from an untrusted network, such as the Internet. Level 0 202, level 1 204, level 2 206, and level 3 208 may be associated with operational technology (OT) 216. OT may refer to a broad range of systems that monitor and control physical devices, processes, and events. OT may include hardware and/or software. Level 4 210 and level 5 212 may be associated with information technology 218. IT may refer to managing electronic data, such as gathering, storing, processing, and sharing data securely.

Level 0 202 may be responsible for physical processes. Level 0 202 may include sensors 220a and actuators 222a at a remote site 224. Level 0 202 may also include sensors 220b and actuators 222b at a local plant site 226. In an example, the sensors 220a and/or the sensors 220b may be or include temperature sensors, cameras, etc. In an example, the actuators 222a and/or the actuators 222b may be or include hydraulic actuators, electric actuators, pneumatic actuators, etc.

Level 1 204 may include instruments that send commands to devices in level 0 202. Level 1 204 may include programmable logic controls (PLCs) 228a at the remote site 224 and PLCs 228b at the local plant site 226. PLC may refer to a type of real-time computer designed to manage input and output of processes. PLC may include hardware, firmware, an operating system (OS), and/or applications. Level 1 204 may also include remote terminal units (RTUs) 230 at the remote site 224. An RTU may refer to a microprocessor-based electronic device used in an ICS to connect hardware to a distributed control system (DCS) or a supervisory control and data acquisition system (SCADA). Level 1 204 may also include DCS controllers 232 at the local plant site 226. DCS may refer to a computerized system that automates industrial processes by distributing control functions across multiple geographically dispersed controllers throughout a plant or factory. Level 1 204 may also include a safety instrumented system (SIS) 234. SIS may refer to a system that monitors processes and that takes action to ensure safety. Level 1 204 may also include an industrial switch (IS) 236a at the remote site 224 and an IS 236b at the local plant site 226. An IS may refer to a networking device that connects and manages communications between devices in industrial settings.

Level 2 206 may include systems that supervise, monitor, and control physical processes. Level 2 206 may include SCADA and a human machine interface (HMI) 238. SCADA may refer to a computer-based system that monitors and controls industrial processes. HMI may refer to a graphical user interface (GUI) application that allows for interaction between a human operator and controller hardware. Level 2 206 may also include HMI, servers, and host log collectors 240. Level 2 206 may also include an IS 236c. Level 2 206 may further include a scanner 242 that is configured to perform functionality pertaining to adaptive and context-aware scanning as described herein.

Level 3 208 may include customized devices that manage production workflows. Level 3 208 may include a historian 244. A historian may refer to systems that collect and store data, including telemetry, events, alerts, and alarms about an operational process and supporting devices. Level 3 208 may also include a firewall 246a. A firewall may refer to a network security device that monitors and filters incoming and outgoing network traffic based on an established security policy of an organization.

Level 3.5 214 may include security systems such as firewalls and proxies used to prevent lateral threat movement between IT and OT. Level 3.5 214 may include a jump server, antivirus (AV), and patch server 248. A jump server may refer to a secure computer that acts as a gateway between two or more networks.

Level 4 210 may include a firewall 246b. Level 4 210 may also include security information and event management (SIEM) 250. SIEM may refer to a system that monitors and manages security events in ICS. A security operations center (SOC) 252 may interact with the SIEM 250 in order to respond to security incidents.

Level 5 212 may include web servers 254. Level 5 212 may also include email servers 256.

Although the description herein focuses on ICS devices, it is to be understood that the concepts presented herein may also be applicable to non-ICS devices.

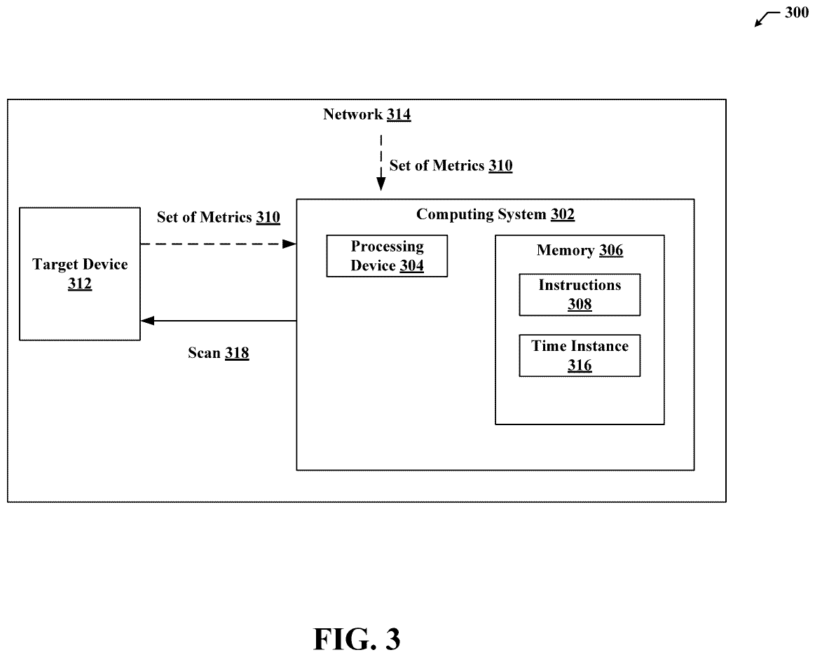

FIG. 3 is a block diagram 300 that illustrates an example of a computing system 302 for adaptive and context-aware scanning in accordance with some aspects of the present disclosure. In some aspects, the computing system 302 may perform some or all of the functionality described herein. The computing system 302 includes a processing device 304 and memory 306. The memory 306 stores instructions 308 that are executed by the processing device 304. The instructions 308, when executed by the processing device 304, cause the processing device 304 to: obtain a set of metrics 310 associated with at least one of: a target device 312 in a network 314 or the network 314; determine, based on the set of metrics 310, a time instance 316 at which to perform a scan 318 of the target device 312; and perform the scan 318 of the target device 312 at the time instance 316.

Some cybersecurity solutions may utilize a network scanner to discover hosts and services on a network by sending packets and analyzing responses. The network scanner may use native queries to elicit information from target devices. However, using a network scanner in such a manner may overwhelm target endpoints. In an example, using the network scanner in such a manner may bring down ICS devices or leave ICS devices in a confused state that may cause a wide range of technical issues, including rendering an ICS device (i.e., an end ICS device) inoperable. In some aspects, using network scanner native queries to scan a target device may not work because an ICS device network stack may be fragile, an ICS device may be left in a confused state causing technical issues, including a spike in CPU utilization and/or memory utilization, an ICS network may be flooded, and/or a source device may be busy and unavailable for core work.

To address the aforementioned deficiencies of network scanners, guardrails may be established to prevent an ICS device from becoming overwhelmed during scanning. However, the guardrails may not include details pertaining to a time at which to perform a scan of a device (e.g., an ICS device).

Described herein are various technologies pertaining to adaptive and context-aware scanning: implementing scanning techniques that adapt based on device type, network conditions, and operational context to minimize disruption. In some aspects described herein, a small amount of information may be collected through “low-cost” means first. The information may be collected to understand a MAC address and to use an OUI to select an appropriate ICS protocol to obtain detailed information about a target device (e.g., an ICS device). Using the “low-cost” means followed by obtaining the detailed information through the appropriate ICS protocol may prevent launching “all-out” scans that behave the same way regardless of a type of the target device. Aspects presented herein may utilize both network protocols and specialized ICS/OT protocols to gather liveness data and device information. The aforementioned protocols may include guardrails. In some aspects, the device information is a data model that is mapped to an ontology to discover Internet-of-Things (IoT) devices. In some aspects, a cloud may analyze collected data to classify devices into categories and to generate a device profile.

In some aspects described herein, a network condition may be monitored to collect the following metrics for a scan: a round-trip time for packets between a scanner and target devices for a network, a time of scanning, site information, etc. A goal of collecting the metrics may be to understand a network latency in order to understand network congestion and/or network overload. The metrics may include an amount of data transmitted over the network. A significant drop in throughput may indicate that the network is becoming saturated. The metrics may include a variability of packet arrival times and/or indications of packet loss.

In some aspects described herein, context-aware scanning may be performed. Operational context information may be collected, such as normal operation schedules, maintenance windows, and emergency situations/behaviors. The operational context information may be collected through integrations with ICS/OT management systems. The operational context information may be collected using a SCADA system API to obtain real-time data on a device status and network load, using an OPC UA to gather device data from various sources and systems, using SNMP to retrieve data from network switches and routers, and/or by polling modbus devices for status information and operational metrics.

In some aspects described herein, a dynamic adjustment of scanning may be performed. Scanning parameters may be adjusted based on an identified context and real-time network conditions. The data obtained from SCADA systems may be used to understand a device status and network load. In some aspects, scanning parameters may be avoided based on a current operational state. A scanning frequency and/or intensity may be adjusted based on data retrieved from the SCADA system. Types of scanning may include port scanning, OS detection, UDP scanning, file scanning, and/or vulnerability detection. Port scanning may find open ports on a network or system and may identify whether a port is open, closed, or filtered. OS detection may find an OS, a version of the OS, and other details pertaining to the OS. UDP scanning may scan using UDP protocols, which may be advantageous for scanning UDP-based services. File scanning may use a “vulners” script to identify outdated services that are vulnerable to known security issues. Vulnerability detection may execute probes to check for specific vulnerabilities.

While some ICS/OT security vendors may offer a capability to understand end devices and query end devices based on protocols, such vendors may not provide the ability to also understand network conditions with increased context-awareness to dynamically adjust what is being scanned based on the identified context and real-time network conditions. Such vendors may also not provide for selecting an appropriate ICS protocol while establishing guardrails.

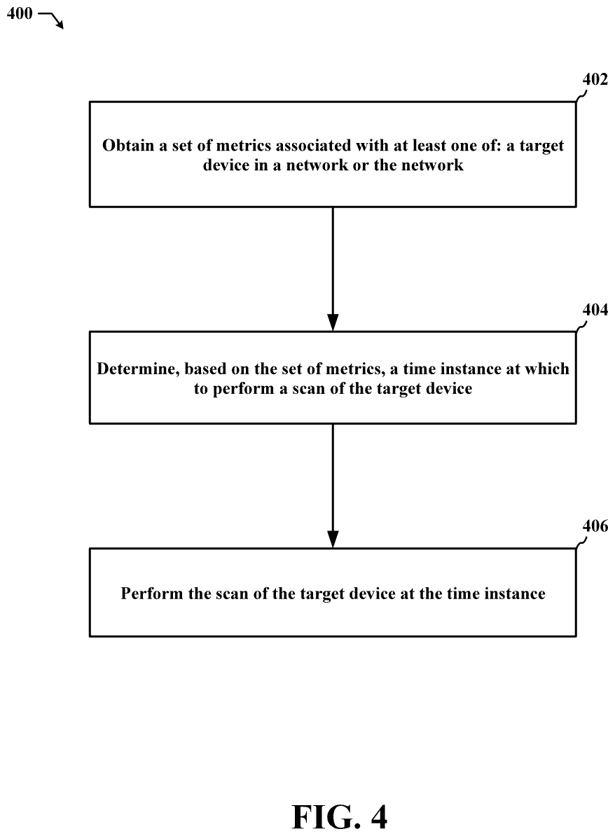

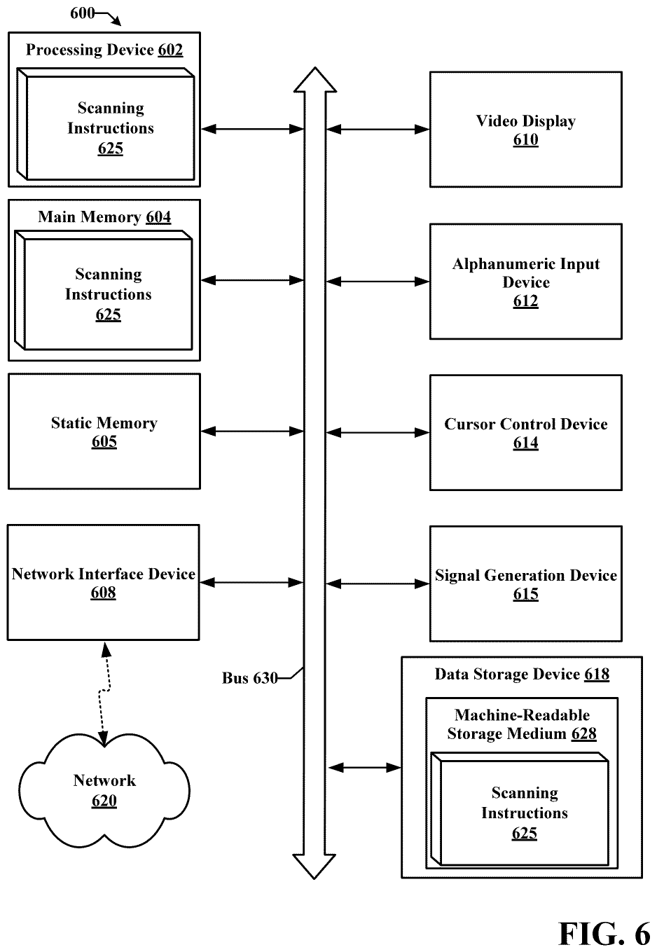

FIG. 4 a flow diagram 400 of a method for adaptive and context-aware scanning in accordance with some aspects of the present disclosure. The method may be performed by processing logic that may include hardware (e.g., a processing device), software (e.g., instructions running/executing on a processing device), firmware (e.g., microcode), or a combination thereof. In some aspects, at least a portion of the method may be performed by the computing system 104 (shown in FIG. 1), the processing device 106 (shown in FIG. 1), the scanner 242 (shown in FIG. 2), the processing device 304 (shown in FIG. 3), the computer system 600 (shown in FIG. 6), the processing device 602 (shown in FIG. 6), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

At block 402, a processing device obtains a set of metrics associated with at least one of: a target device in a network or the network. For example, the set of metrics may be or include the set of metrics 122, the target device may be or include the target device 112, and the network may be or include the network 102. In another example, the set of metrics and the target device may be associated with devices in level 1 204. In a further example, the set of metrics may be or include the set of metrics 310, the target device may be or include the target device 312, and the network may be or include the network 314.

At block 404, the processing device determines, based on the set of metrics, a time instance at which to perform a scan of the target device. For example, the time instance may be or include the time instance 124 and the scan may be or include the scan 128. In another example, the time instance may be or include the time instance 316 and the scan may be or include the scan 318.

At block 406, the processing device performs the scan of the target device at the time instance. For example, the computing system 104 may perform the scan 128 of the target device 112 at the time instance. In some aspects, the processing device may perform the scan of the target device at the time instance to detect a security vulnerability, detect a cybersecurity threat, probe a status of the target device, etc.

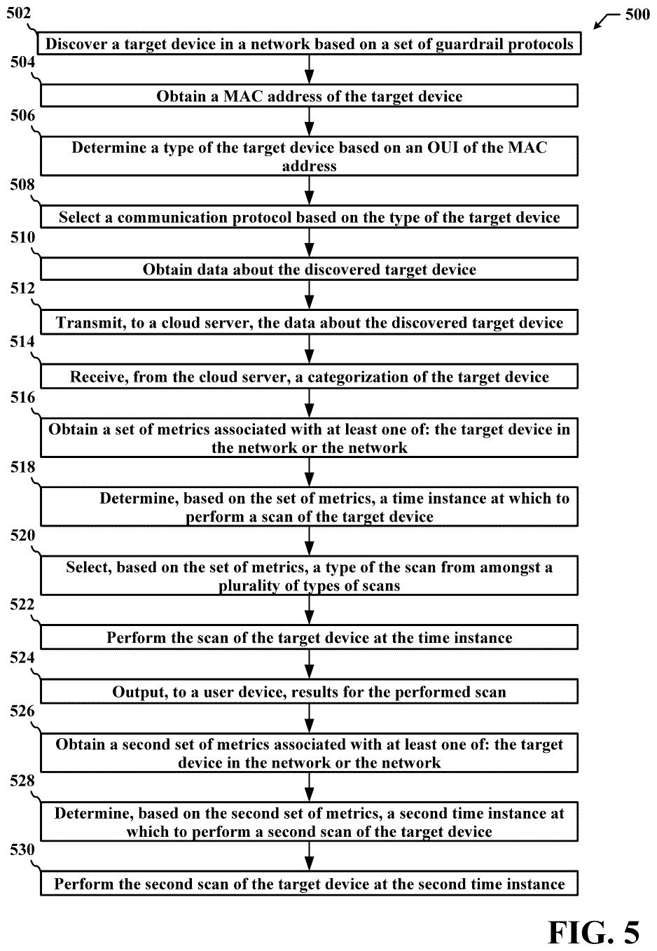

FIG. 5 is a flow diagram 500 of a method for adaptive and context-aware scanning in accordance with some aspects of the present disclosure. The method may be performed by processing logic that may include hardware (e.g., a processing device), software (e.g., instructions running/executing on a processing device), firmware (e.g., microcode), or a combination thereof. In some aspects, at least a portion of the method may be performed by the computing system 104 (shown in FIG. 1), the processing device 106 (shown in FIG. 1), the scanner 242 (shown in FIG. 2), the processing device 304 (shown in FIG. 3), the computer system 600 (shown in FIG. 6), the processing device 602 (shown in FIG. 6), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

At block 502, a processing device may discover a target device in a network based on a set of guardrail protocols. In some aspects, the target device may be or include an ICS device. In some aspects, the target device communicates via a non-TCP protocol. For example, the target device may be or include the target device 112, the network may be or include the network 102, and/or the set of guardrail protocols may be or include the guardrail protocols 140. In another example, the target device may be associated with level 1 204. In another example, the target device may be or include the target device 312 and the network may be or include the network 314.

At block 504, the processing device may obtain a MAC address of the target device. For example, obtaining the MAC address of the target device may correspond to the description of FIG. 1 above.

At block 506, the processing device may determine a type of the target device based on an OUI of the MAC address. For example, determine a type of the target device based on an OUI of the MAC address may correspond to the description of FIG. 1 above.

At block 508, the processing device may select a communication protocol based on the type of the target device. For example, the communication protocol may be or include the communication protocol 116.

At block 510, the processing device may obtain data about the discovered target device. For example, the data about the discovered target device may be or include the discovery data 120.

At block 512, the processing device may transmit, to a cloud server, the data about the discovered target device. For example, the cloud server may be or include the cloud server 123.

At block 514, the processing device may receive, from the cloud server, a categorization of the target device. For example, the categorization may be or include the categorization 127.

At block 516, the processing device obtains a set of metrics associated with at least one of: the target device in the network or the network. In some aspects, the set of metrics may include at least one of: a round-trip time for a packet between a scanner and the target device, an amount of data transmitted over the network, a variation in packet arrival times associated with the target device, a location of the target device, an operational schedule of the target device, a maintenance window of the target device, or packet loss associated with the target device. In some aspects, obtaining the set of metrics may be based on the communication protocol. In some aspects, obtaining the set of metrics may include obtaining the set of metrics based on the discovered target device. In some aspects, obtaining the set of metrics may be based on the categorization of the target device. For example, the set of metrics may be or include the set of metrics 122. In another example, the set of metrics may be or include the set of metrics 310.

In some aspects, obtaining the set of metrics may include at least one of: obtaining the set of metrics via a supervisory control and data (SCADA) system application programming interface (API), obtaining the set of metrics via an open platform communications (OPC) unified architecture (UA), obtaining the set of metrics via a simple network management protocol (SNMP), or obtaining the set of metrics via a modbus poll. For example, obtaining the set of metrics may correspond to the description of FIG. 1 above.

At block 518, the processing device determines, based on the set of metrics, a time instance at which to perform a scan of the target device. In some aspects, the time instance may be associated with at least one of: a processor usage of the target device being below a threshold processor usage, a memory usage of the target device being below a threshold memory usage, or a network usage of the network being below a threshold network usage. In some aspects, determining the time instance may further include determining a frequency for the scan. In some aspects, determining the time instance at which to perform the scan of the target device may include determining the time instance additionally based on a categorization of the target device. For example, the time instance may be or include the time instance 124. In another example, the time instance may be or include the time instance 316. In an example, the scan may be or include the scan 128. In another example, the scan may be or include the scan 318.

At block 520, the processing device may select, based on the set of metrics, a type of the scan from amongst a plurality of types of scans. In some aspects, performing the scan of the target device may be based on the communication protocol. For example, the plurality of types of scans may correspond to the scans 134.

At block 522, the processing device performs the scan of the target device at the time instance. In some aspects, the scan may include at least one of: a port scan, an OS scan, a UDP scan, a fil scan, or a vulnerability detection scan. In some aspects, performing the scan of the target device may include performing the type of the scan. In some aspects, performing the scan of the target device may include performing the scan of the target device at the frequency.

At block 524, the processing device may output, to a user device, results for the performed scan. For example, the user device may be or include the user device 132 and the results for the performed scan may be or include the scan results 130.

At block 526, the processing device may obtain a second set of metrics associated with at least one of: the target device in the network or the network, where the second set of metrics differs from the set of metrics. For example, obtaining the second set of metrics may correspond to the description of FIG. 1 above.

At block 528, the processing device may determine, based on the second set of metrics, a second time instance at which to perform a second scan of the target device. For example, determining the second time instance may correspond to the description of FIG. 1 above.

At block 530, the processing device may perform the second scan of the target device at the second time instance, where at least one of: a type of the second scan differs from a type of the scan or a frequency of the second scan differs from a frequency of the scan. For example, performing the second scan of the target device may correspond to the description of FIG. 1 above.

FIG. 6 illustrates a diagrammatic representation of a machine in the example form of a computer system 600 within which a set of instructions, for causing the machine to perform any one or more of the methodologies discussed herein for adaptive and context-aware scanning.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, the computer system 600 may be representative of a server.

The computer system 600 includes a processing device 602, a main memory 604 (e.g., read-only memory (ROM), flash memory, dynamic random access memory (DRAM), a static memory 605 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 600 may further include a network interface device 608 which may communicate with a network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 615 (e.g., an acoustic signal generation device, such as a speaker). In some embodiments, the video display unit 610, the alphanumeric input device 612, and the cursor control device 614 may be combined into a single component or device (e.g., an LCD touch screen).

The processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute scanning instructions 625, for performing the operations and steps discussed herein. For example, the scanning instructions 625 may include instructions for obtaining a set of metrics associated with at least one of: a target device in a network or the network. The scanning instructions 625 may include instructions for determining, based on the set of metrics, a time instance at which to perform a scan of the target device. The scanning instructions 625 may include instructions for performing the scan of the target device at the time instance.

The data storage device 618 may include a machine-readable storage medium 628 that stores the scanning instructions 625 (e.g., software) embodying any one or more of the methodologies of functions described herein. The scanning instructions 625 may also reside, completely or at least partially, within the main memory 604 or within the processing device 602 during execution thereof by the computer system 600; the main memory 604 and the processing device 602 also constituting machine-readable storage media. The scanning instructions 625 may further be transmitted or received over a network 620 via the network interface device 608.

While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “obtaining,” “determining,” “performing,” “scanning,” “selecting,” “identifying,” “discovering,” “transmitting,” “receiving,” “inputting,” “outputting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission, or display devices. Also, the terms “first,” “second,” “third,” “fourth” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112 (f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method, comprising:
obtaining a set of metrics associated with at least one of a target device in a network or the network;
determining, by a processing device and based on the set of metrics, a time instance at which to perform a scan of the target device; and
performing the scan of the target device at the time instance.

2. The method of claim 1, wherein the target device comprises an industrial control systems (ICS) device.

3. The method of claim 1, wherein the target device communicates via a non-transmission control protocol (non-TCP).

4. The method of claim 1, wherein the scan comprises at least one of:
a port scan;
an operating system (OS) scan;
a user datagram protocol (UDP) scan;
a file scan; or
a vulnerability detection scan.

5. The method of claim 1, wherein the set of metrics comprises at least one of:
a round-trip time for a packet between a scanner and the target device;
an amount of data transmitted over the network;
a variation in packet arrival times associated with the target device;
a location of the target device;
an operational schedule of the target device;
a maintenance window of the target device; or
packet loss associated with the target device.

6. The method of claim 1, further comprising:
obtaining a medium access control (MAC) address of the target device;
determining a type of the target device based on an organizationally unique identifier (OUI) of the MAC address; and
selecting a communication protocol based on the type of the target device, wherein at least one of the obtaining the set of metrics or the performing the scan of the target device is based on the communication protocol.

7. The method of claim 1, further comprising:
discovering the target device in the network based on a set of guardrail protocols, wherein the obtaining the set of metrics comprises obtaining the set of metrics based on the discovered target device.

8. The method of claim 7, further comprising:
obtaining data about the discovered target device;
transmitting, to a cloud server, the data about the discovered target device; and
receiving, from the cloud server, a categorization of the target device, wherein the obtaining the set of metrics is based on the categorization of the target device.

9. The method of claim 1, further comprising:
selecting, based on the set of metrics, a type of the scan from amongst a plurality of types of scans, wherein the performing the scan of the target device comprises performing the type of the scan.

10. The method of claim 1, wherein the obtaining the set of metrics comprises at least one of:
obtaining the set of metrics via a supervisory control and data (SCADA) system application programming interface (API);
obtaining the set of metrics via an open platform communications (OPC) unified architecture (UA);
obtaining the set of metrics via a simple network management protocol (SNMP); or
obtaining the set of metrics via a modbus poll.

11. The method of claim 1, wherein the time instance is associated with at least one of:
a processor usage of the target device being below a threshold processor usage;
a memory usage of the target device being below a threshold memory usage; or
a network usage of the network being below a threshold network usage.

12. The method of claim 1, wherein the determining the time instance further comprises determining a frequency for the scan, and wherein the performing the scan of the target device comprises performing the scan of the target device at the frequency.

13. The method of claim 1, further comprising:
outputting, to a user device, results for the performed scan.

14. The method of claim 1, further comprising:
obtaining a second set of metrics associated with at least one of: the target device in the network or the network, wherein the second set of metrics differs from the set of metrics;
determining, based on the second set of metrics, a second time instance at which to perform a second scan of the target device; and
performing the second scan of the target device at the second time instance, wherein at least one of:
a type of the second scan differs from a type of the scan; or
a frequency of the second scan differs from a frequency of the scan.

15. The method of claim 1, wherein the determining the time instance at which to perform the scan of the target device comprises determining the time instance additionally based on a categorization of the target device.

16. A system, comprising:
a processing device; and
a memory to store instructions that, when executed by the processing device, cause the processing device to:
obtain a set of metrics associated with at least one of: a target device in a network or the network;
determine, based on the set of metrics, a time instance at which to perform a scan of the target device; and
perform the scan of the target device at the time instance.

17. The system of claim 16, wherein the target device comprises an industrial control systems (ICS) device.

18. The system of claim 16, wherein the set of metrics comprises at least one of:
a round-trip time for a packet between a scanner and the target device;
an amount of data transmitted over the network;
a variation in packet arrival times associated with the target device;
a location of the target device;
an operational schedule of the target device;
a maintenance window of the target device; or
packet loss associated with the target device.

19. A non-transitory computer readable medium, having instructions stored thereon which, when executed by a processing device, cause the processing device to:
obtain a set of metrics associated with at least one of: a target device in a network or the network;
determine, by the processing device and based on the set of metrics, a time instance at which to perform a scan of the target device; and
perform the scan of the target device at the time instance.

20. The non-transitory computer readable medium of claim 19, wherein the target device comprises an industrial control systems (ICS) device.
